(19) United States
(12) Patent Application Publication
(10) Pub. No.: US 2013/0104744 A1
(43) Pub. Date: May 2, 2013

(54) Satay grill rack

(71) Applicant: Steve Oi, Vernon Hiils, IL (US)

(72) Inventor: Steve Oi, Vernon Hiils, IL (US)

(21) Appl. No.: 13/317,817

(22) Filed: Oct. 31, 2011

(51) Int. Cl. A47J 37/04

(52) U.S. Cl. 99/421 H

(57) ABSTRACT

A satay grill rack comprised of a metal grill rack and a metal grill bar which, when assembled together, holds up satay meat skewers for grilling on a barbecue grill. The rack elevates the satay meat skewers above the surface of the barbecue grill and with the aid of a heat shield, makes holding the handle of the satay meat skewers easier and safer and reduces the chance of bamboo skewer handles burning. The grill rack is adjustable and can accommodate a plurality of meat skewers of different lengths.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The purpose of this invention is to make the cooking of satays easier.

Satays are slices, cubes or small chunks of meat that are impaled onto pointed skewers and cooked over a hot grill. The most common skewer is made from bamboo, a plentiful grass that grows in tropical regions. Bamboo skewers are sturdy, inexpensive and widely available. Chunks of meat are typically impaled onto the bamboo skewers, occupying about half the length of the skewer and leaving the other half of the skewer empty to act as a handle for cooking the skewer over a hot grill and for holding the skewer while eating the meat. Satays are prepared, cooked, consumed, and enjoyed around the world.

Cooking satays over a hot grill is sometimes difficult as the bamboo skewer handles may dry out and burn if subjected to high heat. If the handle burns, the meat section of the satay may break off from the handle and fall into the hot grill, necessitating the use of tongs or other implements to retrieve the meat from the heat. Loss of the handle also makes eating the satay less convenient as eaters cannot hold the satay, necessitating the use of eating implements such as a knife and fork. Even worse, the meat section may break off and fall onto the floor, leading to loss of food.

To reduce the chances of bamboo skewer handles burning, cooks around the world have been advised in countless cookbooks and by cooking professionals to pre-soak in water their bamboo skewers for 30 minutes or more to add moisture to the bamboo and reduce the risk of burning. This may be inconvenient for cooks as additional thought and effort are involved in pre-soaking the bamboo skewers prior to using them. Depending on cooking time and grill temperatures, pre-soaking may not provide adequate protection and bamboo skewer handles may still burn.

Commercially manufactured barbecue grills present an additional challenge to cooks in that barbecue grill grates are typically oriented north to south. If satays are placed onto the cooking grate parallel to the grill's cooking grates, the satays may fall in between the grates if the meat on the skewers is not of sufficient thickness, increasing the risk of losing the satay all together, and burning the meat as well as the bamboo handle. Avoiding this problem necessitates placing the satays perpendicular to the grill grates, with the handles of the skewers near the side of the grill. However, placing satays on the side of the grill may be inconvenient or impossible depending on the design of the grill and whether there is room on the side of the grill for the skewer handles.

A heat shield, such as a sheet of aluminum foil, may provide some heat protection for bamboo handles, but the handles sit closely to the heat shield making holding or touching the handles potentially difficult due to the heat of the barbecue grill. Additionally, satays and the heat shield must be placed perpendicular to the grill's cooking grates to reduce the chance of the satays falling in between the grill grates.

My invention makes cooking satays easier by reducing the risk of bamboo skewer handles burning, by making it easier and safer to hold the bamboo handles while satays are cooking and by reducing the chance of satays falling in between grill grates into the hot grill. Since my invention reduces the heat that bamboo skewer handles is exposed to, the need to pre-soak bamboo skewers in water is eliminated.

BRIEF SUMMARY OF THE INVENTION

The satay grill rack is comprised of a metal grill rack with a metal grill bar which, when assembled together and placed on the cooking grate of a heated barbecue grill, holds up satay meat skewers for grilling. The rack elevates the satay meat skewers above the surface of the grill and with the aid of a heat shield, makes holding the handles of the satay meat skewers easier and safer and reduces the chance of the bamboo skewer handles burning. The front wall of the grill rack and the grill bar create parallel, cross-wise surfaces so that meat skewers may be laid onto the surfaces. The grill rack is adjustable and can accommodate meat skewers of different lengths.

### BRIEF DESCRIPTION OF THE SEVERAL VIEWS OF THE DRAWING

FIG. 1 is a frontal perspective view of the grill rack and grill bar.

FIG. 2 is a frontal perspective view of the grill rack with installed grill bar shown with several satays placed on top of the grill rack.

FIG. 3 is a frontal perspective view of the grill rack with installed grill bar placed on top of a barbecue grill grate.

### DETAILED DESCRIPTION OF THE INVENTION

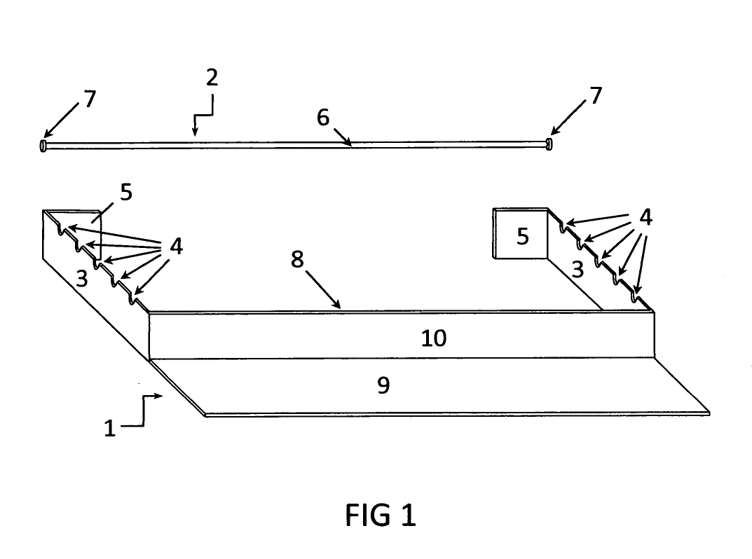

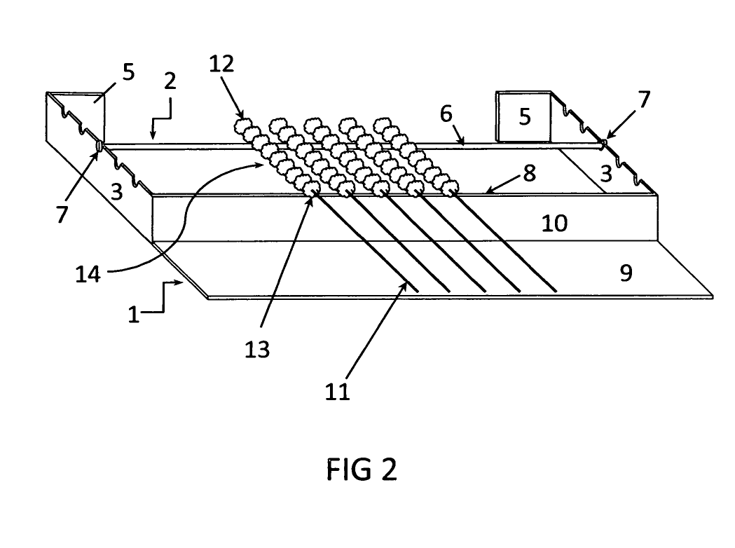

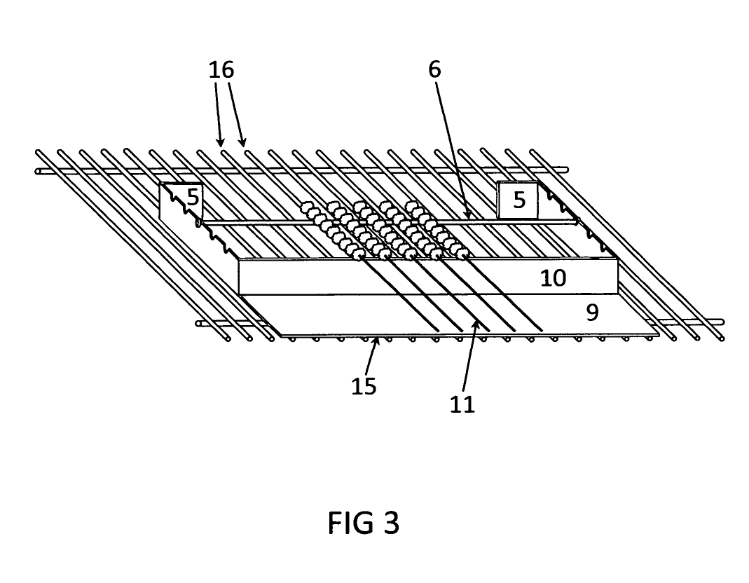

As depicted in FIG. 1, this invention is comprised of a metal grill rack 1 and a metal grill bar 2. When assembled together, the grill rack 1 with installed grill bar 2 will hold up meat skewers for cooking, as shown in FIG. 2. The grill rack 1 is placed flat onto the grill grate 16 of a heated barbecue grill with the heat shield 9 facing the front of the grill and laying on top of the grill grate, as shown in FIG. 3. The front edge 15 of the heat shield abuts the front wall or front edge of the barbecue grill.

The preferred embodiment of the satay grill rack is fabricated from sheet metal that is suitable for cooking, such as foodservice quality stainless steel or aluminum. The sheet metal is of a thickness that can maintain the shape of the rack even when heated to high grill temperatures and strong enough to support a plurality of satay meat skewers placed on the rack. The grill bar 2 is a solid, cylindrical grill bar shaft 6 made from metal suitable for cooking and of a thickness that can maintain the shape of the shaft even when heated to high grill temperatures and strong enough to support a plurality of satay meat skewers placed on the grill bar. The ends of the grill bar shaft 6 terminate with metal stops 7. The metal stops 7 hold the grill bar shaft 6 in place when the grill bar shaft 6 is installed onto corresponding notches 4 on top of the side walls 3 of the grill rack, as shown in FIG. 2. When assembled together, the grill rack and the grill bar are strong enough to support a plurality of satay meat skewers placed onto the front wall 10 of the rack and the grill bar shaft 6.

The grill rack 1 is rectangular in shape and is comprised of a front wall 10 with connected flat heat shield 9, two side walls 3, and two rear wall sections 5. All walls are connected to each other at 90 degree angles. The preferred embodiment of the grill rack has a front wall 10 that is 16 inches wide. The side walls 3 are 6 inches wide and the rear wall sections 5 are each 2 inches wide. All walls are 2 inches in height. The heat shield 9 is a rectangular section of sheet metal joined to the bottom edge of the front wall at 90 degrees and extends towards the front by 3 inches. The grill bar 2 is a grill bar shaft 6 that is 16½ inches long. The length of the grill bar 2 must be somewhat longer than the width of the rack so that the grill bar shaft 6 may rest on the side walls 3 of the grill rack. The diameter of the grill bar shaft 6 is ¼ inch. The metal stops 7 at the end of the grill bar shaft 6 are wider than the diameter of the grill bar shaft 6 so that the grill bar shaft 6 will sit securely on the side walls 3 and not fall off the rack. The diameter of the metal stops 7 is ½ inch.

The top edge of the front wall 10 and the grill bar 2 together elevate the satay meat skewers above the surface of the grill and with the aid of the heat shield 9, makes holding and touching the skewer handles 11 of the satay meat skewers easier and safer and reduces the chance of bamboo skewer handles burning. A person cooking the satay meat skewers may hold the bamboo skewer handles 11 to reposition the satays, flip the satays or remove the satays during the cooking process with reduced risk of burning his or her fingers or hands.

The side walls 3 have notches 4 pre-cut into the top edge of each side wall 3 at one inch intervals, as shown in FIG. 1. The notches 4 are of a sufficient width and depth so that the grill bar shaft 6 may rest in place in corresponding notches in the opposite side walls 3. When resting in place, the grill bar shaft 6 will be parallel to the top edge 8 of the front wall 10, and the top surface of the grill bar shaft 6 will be same height as the top edge 8 of the front wall 10, creating a parallel set of cooking surfaces that are level with the cooking grate of the barbecue grill. Repositioning the grill bar 2 by placing it in a different set of corresponding notches 4 changes the distance between the front wall 10 and the grill bar shaft 6 so as to accommodate a plurality of satay meat skewers of different lengths. The grill bar 2 is placed in corresponding notches 4 such that the distance between the front wall 10 of the rack and the grill bar shaft 6 is somewhat less than the length of the meat section of a satay meat skewer, as shown in FIG. 2. Ideally, the space between the front wall 10 and grill bar shaft 6 should be about 80% of the length of the meat section of a satay skewer.

The top edge 8 of the front wall 10 of the rack and the grill bar shaft 6 create a parallel set of narrow surfaces that run cross-wise from left to right on the grill. Satay meat skewers 12 are placed perpendicularly onto theses parallel surfaces, with the bottom edge 13 of the meat section 14 of a satay skewer placed directly onto the top edge 8 of the front wall 10 and the top portion of the meat section 14 of the satay skewer placed directly across the grill bar shaft 6. The bamboo handles 11 of the satay meat skewers will protrude above the rack's heat shield 9 and towards the front of the grill.

Although the description above contains many specifics, these should not be construed as limiting the scope of the invention, but merely providing illustration of some of the presently preferred embodiments of this invention.

I claim:

1. A satay grill rack comprised of a metal grill rack and a metal grill bar which, when assembled together and placed on the cooking grate of a heated barbecue grill, holds up satay meat skewers for grilling.

2. The grill rack in claim 1 is rectangular in shape and is comprised of a front wall with connected flat heat shield, two side walls with corresponding notches on their top edges at intervals, and two rear wall sections.

3. The heat shield of the grill rack in claim 1 is a flat sheet of metal that extends from the bottom of the front wall towards the front of the grill rack.

4. The grill rack in claim 1 is fabricated from sheet metal that can withstand high cooking temperatures and retain is shape, rigidity and strength.

5. The grill bar in claim 1 is a metal, cylindrical shaft whose length is longer than the width of the grill rack so that the grill bar may rest on corresponding notches on the top edges of the side walls of the grill rack.

6. The grill bar in claim 1 has metal stops at each end that prevent the grill bar from falling off the grill rack.

7. The grill bar in claim 1 is fabricated from a metal rod that can withstand high cooking temperatures and retain is shape, rigidity and strength.

8. The top edge of the front wall of the grill rack and the grill bar in claim 1, when assembled together, create a parallel set of narrow surfaces running cross-wise from left to right so that the meat sections of satay meat skewers may be laid on top of these surfaces perpendicular to the two surfaces.

9. The top edge of the front wall of the grill rack and the grill bar in claim 1, when assembled together, elevate satay meat skewers above the hot surface of the barbecue grill, and with the aid of a heat shield, makes holding the handles of the satay meat skewers easier and safer and reduces the chance of bamboo skewer handles burning.

10. The grill bar of the grill rack in claim 1 is adjustable and can be repositioned using corresponding, pre-cut notches in the top edges of the side walls of the grill rack so that the distance between the top edge of the front wall and the grill bar may be widened or reduced to accommodate a plurality of skewers of different lengths.
